(19) United States
(12) Patent Application Publication
(10) Pub. No.: US 2025/0254066 A1
(43) Pub. Date: Aug. 7, 2025

(54) ITERATIVE MIMO DETECTION USING STOCHASTIC SAMPLING

(71) Applicant: L3Harris Technologies, Inc., Melbourne, FL (US)

(72) Inventors: Stephen N. Jenkins, Layton, UT (US); Behrouz Farhang, Salt Lake City, UT (US)

(21) Appl. No.: 19/182,757

(22) Filed: Apr. 18, 2025

Related U.S. Application Data
(63) Continuation-in-part of application No. 18/944,405, filed on Nov. 12, 2024.
Application No. 18/944,405 is a continuation-in-part of application No. 18/793,560, filed on Aug. 2, 2024.
(60) Provisional application No. 63/550,548, filed on Feb. 6, 2024.

(51) Int. Cl. H04L 25/02; H04B 7/0413; H04L 25/03

(52) U.S. Cl. CPC H04L 25/0204; H04L 25/0224; H04L 25/03318; H04B 7/0413

(57) ABSTRACT

Systems and methods for symbol detection. The methods comprising: receiving, by a receiver, a signal that was transmitted in a single carrier transmission system; detecting, by a processor of the receiver, a plurality of first symbols in the received signal that are to be detected and a plurality of second symbols in the received signal that are to be considered interfering symbols; cancelling, by the processor, interference from the received signal using the plurality of second symbols to obtain a modified received signal; obtaining, by the processor, soft values using a stochastic detection algorithm that considers each of the plurality of first symbols as being transmitted from respective virtual transmitters and received by respective virtual receivers; and using the soft values to recover symbols from the received signal.

### CROSS-REFERENCE TO RELATED APPLICATIONS

This application is a Continuation-In-Part of U.S. Non-Provisional patent application Ser. No. 18/944,405 filed on Nov. 12, 2024 (“the '405 Application”). The '405 Application is a Continuation-In-Part of U.S. Non-Provisional patent application Ser. No. 18/793,560 filed on Aug. 2, 2024, which claims the benefit of and priority to U.S. Provisional Patent Application Ser. No. 63/550,548 filed on Feb. 6, 2024. The contents of the listed U.S. Non-Provisional and Provisional Patent Applications are expressly incorporated herein by reference in their entireties.

### BACKGROUND

### Description of the Related Art

Digital communication techniques have rapidly evolved in recent times. Such digital communications can be performed over wired or wireless channels. Wireless communications are described as “over-the-air” communications.

One area of innovation in communication systems is bandwidth capacity. In particular, there is research and innovation directed to increasing the data rate that data can be transmitted on a given channel. That is, research is directed to methods and systems that can be used for increasing capacity for transmitting more data on a channel during a particular period of time than was previously known to be possible.

One method that has been used to increase channel capacity is referred to as multiple-input and multiple-output (MIMO). MIMO exploits multipath propagation to increase channel capacity. This may be referred to as spatial multiplexing. Multipath propagation refers to the phenomenon of radio signals from a source transmitter reaching a destination receiver via two or more different paths. This may be due to signals reflecting off of: obstacles, the atmosphere, bodies of water, etc.; refraction from the atmosphere or bodies of water; etc. A MIMO transmitter may choose to transmit multiple streams of data from an M point quadrature amplitude modulated (QAM) constellation in parallel through different transmit antennas.

On the receiver side, detection of multiple streams via multiple paths results in significant complexity being required to detect and decode transmitted data. In particular, transmitted data is often encoded with an error correction code or error correcting code (ECC) implementing forward error correction (FEC). As data is transmitted, portions of the data may be lost due to channel effects including distortion and noise. Using FEC techniques, codewords are created at the transmitter from the payload data. The codewords are transmitted on the channel, where they may become corrupted by the channel effects causing loss of bits in the codewords. Codewords received and detected at the receiver, even though corrupted by losing bits, can be decoded at the receiver to obtain the payload data. In particular, the receiver can perform decoding, sometimes including a soft-decision algorithm, to extract valid data from a detected codeword. However, each additional spatial stream in a MIMO system compounds the number of computations needed in the receiver at an exponential rate.

In particular, iterative, maximum-a-posteriori (MAP) based receivers have been shown to approach the channel capacity for MIMO channels by sharing soft information of the transmitted bits between a detector and a channel decoder. However, optimal implementations of such receivers have a complexity that grows exponentially with the number of streams and modulation order of the transmitted signal. MAP detectors produce soft information, in the form of log-likelihood ratio (LLR) values, that are then passed to an outer channel decoder as extrinsic information. The decoder, using known information about the channel code, refines the LLR values, which are then fed back to the detector as a priori information for the received coded bits. This method is repeated until either 1) no more new information can be generated, or 2) the latency constraint of the system is met. The effectiveness of MAP-based receivers centers on the ability of the detector to reliably generate accurate LLR values of the transmitted bits.

A naive solution for obtaining the LLR values is to exhaustively search over the set of [symbol] all possible bits in each MIMO channel, the full solution space generally being denoted [symbol] . However, this can be infeasible for certain systems. For example, a 16-QAM modulation, 4×4 MIMO system has 16⁴=65,536 solutions. A 16-QAM modulation, 8×8 MIMO system has 16⁸=4,294,967,296 solutions. Complexity grows exponentially with the number of streams and modulation order.

Several techniques have been explored to deal with this complexity, each with their own drawbacks. List based techniques, such as the Sphere Decoder, reduce the search space for possible solutions, thus reducing search time and system latency, but reducing the search space in such a way as to still include the maximum likelihood solution (as indicated by LLR) is difficult. The search area in the Sphere Decoder solution is ambiguous and may lead to unsustainable system latencies if not bounded, but bounded methods do not provide the optimal solution. Bounded methods, such as the K-Best algorithm, implement a search-tree pruning method to achieve reduced and known complexity, but cannot guarantee the selection of the maximum likelihood solution. K-Best is also a sequential search algorithm with multiple costly sorting steps.

The subject matter claimed herein is not limited to embodiments that solve any disadvantages or that operate only in environments such as those described above. Rather, this background is only provided to illustrate one exemplary technology area where some embodiments described herein may be practiced.

### SUMMARY

This document concerns implementing systems and methods for symbol detection. The methods comprise: receiving, by a receiver, a signal that was transmitted in a single carrier transmission system; detecting, by a processor of the receiver, a plurality of first symbols in the received signal that are to be detected and a plurality of second symbols in the received signal that are to be considered interfering symbols; cancelling, by the processor, interference from the received signal using the plurality of second symbols to obtain a modified received signal; obtaining, by the processor, soft values using a stochastic detection algorithm that considers each of the plurality of first symbols as being transmitted from respective virtual transmitters and received by respective virtual receivers; and using the soft values to recover symbols from the received signal.

This document concerns systems comprising a receiver configured to receive a signal that was transmitted in a single carrier transmission system; and a processor configured to recover symbols from the received signal. The symbols are recovered by: detecting a plurality of first symbols in the received signal that are to be detected and a plurality of second symbols in the received signal that are to be considered interfering symbols; cancelling interference from the received signal using the plurality of second symbols to obtain a modified received signal; obtaining soft values using a stochastic detection algorithm that considers each of the plurality of first symbols as being transmitted from respective virtual transmitters and received by respective virtual receivers; and using the soft values to recover the symbols from the received signal.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1 illustrates a MIMO system including a receiver having iterative maximum-a-posteriori (MAP) detection and decoding;

FIG. 2 illustrates an alternative MIMO system;

FIG. 3 illustrates a method of recovering symbols;

FIG. 4 provides an illustration of a system implementing the present solution.

FIG. 5 provides a more detailed block diagram of the transmitter shown in FIG. 4.

FIG. 6 provides a more detailed block diagram of the receiver shown in FIG. 4.

FIG. 7 provides an illustration showing a banded channel matrix.

FIGS. 8-9 provide illustrations that are useful for understanding operations performed by a receiver implementing the present solution.

FIGS. 10-11 each provides a flow diagram of an illustrative method for recovering symbols for a received signal.

FIG. 12 provides an illustration of an architecture for a computing device.

### DETAILED DESCRIPTION

### Iterative MIMO Detection Using Stochastic Sampling

Embodiments illustrated herein identify a subset of highly likely solutions (as indicated by some predetermined criteria), denoted as [symbol] for the full solution space, denoted as [symbol] [symbol] using a Maximum a posteriori (MAP) detection. The subset of solutions [symbol] , are the choices of s (a vector of symbols, where the vector of symbols may be referred to herein as a codeword) that minimize ∥y−Hs∥², which is the maximum likelihood solution. Note that in this context, ∥y−Hs∥² defines a sphere of ‘best guesses’. The set of solutions [symbol] can be used to recover transmitted symbols. Embodiments stochastically sample the full solution space in a vicinity of the minimum mean square error (MMSE). In one specific example, this is performed by performing the following:
Find a sampling center: s_{center}=Wy where W is chosen to be the MMSE estimator matrix W=(H^{H}H+σₙ²I)H^{H}.
Generate a vector v=Wv′ where v′ is a vector of independent and identically distributed Gaussian elements with zero mean and variance σᵥ².
Generate a stochastic sample ŝ=[s_{center}+v] where [·] denotes a hard decision to a closest valid constellation point.
Using the stochastic samples, find a log likelihood ratio (LLR), or soft information of bits using:

$${λ}_{k}^{e} \approx \frac{1}{2} {max}_{x ∈ {𝕃}^{k +}} \{ - \frac{1}{{σ}^{2}} {‖ y - Hs ‖}^{2} + {x}_{∖ k}^{T} \cdot {λ}_{∖ k}^{a} \} - \frac{1}{2} {max}_{x ∈ {𝕃}^{k -}} \{ - \frac{1}{{σ}^{2}} {‖ y - Hs ‖}^{2} + {x}_{∖ k}^{T} \cdot {λ}_{∖ k}^{a} \} \qquad ( 1 )$$

Throughout this document, some specialized notations are used for compactness and clarity. Vectors and matrices are expressed with bold fonts and the latter are capitalized. Scalars are indicated by lower and upper case non-bold letters. The removal of the k-th element of a vector x is signified as xₖ. A bit vector x with the k-th bit forced to +1 or −1 (equivalently, one or zero) is presented as x^{k+} and x^{k-}, respectively.

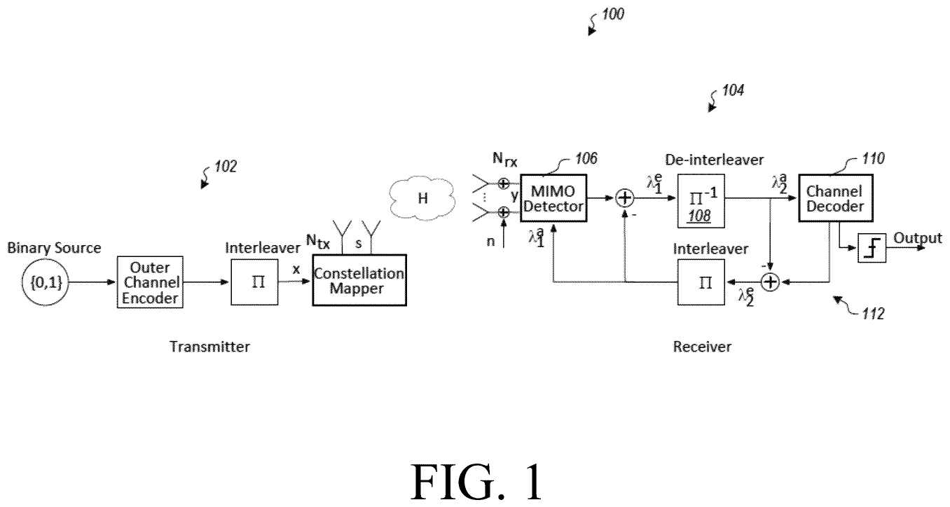

Referring now to FIG. 1, an example is illustrated. FIG. 1 illustrates a MIMO system 100 including a transmitter 102 and receiver 104. The system 100 can be characterized by y=Hs+n where y is a received signal vector, H is a channel gain matrix, s is the vector of transmitted symbols, and n is the channel noise vector of independent and identically distributed Gaussian elements with zero-mean and variance σ². H denotes the channel gain of size Nᵣₓ×Nₜₓ, Nᵣₓ and Nₜₓ are the number of antennas at the receiver and transmitter, respectively.

In the example illustrated, the receiver 104 is constructed to include an iterative detector 106. A MIMO detector 106 and a channel decoder 110 interact over successive iterations, through a feedback loop 112 to improve on the detection performance.

As used herein, Nₜₓ=Nᵣₓ=N.

The receiver 104 includes an iterative MAP detection and decoding system for finding the likelihood of each transmitted bit and improving over successive iterations. The detector 106 collects channel observations y, along with a priori information λ₁^{a}, and derives new information λ₁^{e} for each transmitted bit, in the form of LLR values. The new information, which is also referred to as extrinsic information, is then de-interleaved by the de-interleaver 108 to become the a priori input λ₂^{a} to the channel decoder 110. The channel decoder 110 then performs error correction on the received LLR values and generates extrinsic information about the transmitted bits. The decoder output is then combined with λ₂^{a} to obtain λ₂^{e}. λ₂^{e} interleaved and passed back to the MIMO detector 106 as a priori information λ₁^{a}. This process is repeated multiple times to converge.

The effectiveness of the MAP receiver relies upon the accuracy of the LLR values exchanged between the detector 106 and decoder 110. The extrinsic LLR values are defined as

$${λ}_{k}^{e} = ln \frac{P ( {x}_{k} = + 1 \vert y , {λ}_{\backslash k}^{a} )}{P ( {x}_{k} = - 1 \vert y , {λ}_{\backslash k}^{a} )} \qquad ( 2 )$$

where the subscript k refers to the k-th bit, and subscript \k indicates the removal of the k-th bit. Using Bayes' rule, mathematical equation (2) may be expanded as:

$${λ}_{k}^{e} = ln \frac{{\sum }_{x ∈ {𝕏}^{k +}} ( p ( y \vert x ) {\prod }_{j \neq k} p ( {x}_{j} \vert {λ}_{j}^{a} ) )}{{\sum }_{x ∈ {𝕏}^{k -}} ( p ( y \vert x ) {\prod }_{j \neq k} p ( {x}_{j} \vert {λ}_{j}^{a} ) )} \qquad ( 3 )$$

Further, using various known methods, mathematical equation (3) can be rearranged as

$${λ}_{k}^{e} \approx \frac{1}{2} {max}_{x ∈ {𝕏}^{k +}} \{ - \frac{1}{{σ}^{2}} ‖ y - Hs {‖}^{2} + {x}_{∖ k}^{T} \cdot {λ}_{∖ k}^{a} \} - \frac{1}{2} {max}_{x ∈ {𝕏}^{\underline{k}}} \{ - \frac{1}{{σ}^{2}} ‖ y - Hs {‖}^{2} + {x}_{∖ k}^{T} \cdot {λ}_{∖ k}^{a} \} \qquad ( 4 )$$

Here [symbol] and [symbol] are the sets of all permutations of x with the k-th bit forced to +1 or −1, respectively and ∥·∥² refers to the length square of the indicated vector.

As discussed above, the exhaustive search suggested in mathematical equation (4) may soon become intractable, as the size of [symbol] grows exponentially as the constellation size and/or MIMO size increases. To resolve this problem, [symbol] is replaced by a list [symbol] ␣ [symbol] that covers the samples of x that are likely the major contributors to the maximization steps in mathematical equation (4).

Embodiments illustrated here use a search method for generation of a list [symbol] . This list is subsequently used in the iterative MAP detector 106 of FIG. 1. The specific method that is introduced here is referred to as stochastic list generation (SLG). The subset of solutions [symbol] , are the choices of s that are near the minimizer ∥y−Hs∥².

Additional details are now illustrated. As described above, the following steps are taken to generate a set of Li independent samples.
(1) Find a sampling center: s_{center}=Wy where W is chosen to be the MMSE estimator matrix W=(H^{H}H+σₙ²I)H^{H}.
(2) Generate a perturbation vector v=Wv′ where v′ is a N×1 vector of independent and identically distributed Gaussian elements with zero mean and variance σᵥ², such that the standard deviation of the elements of in the perturbation vector v is comparable with the distance between constellation points. In particular,

$${σ}_{{v}^{′}}^{2} = \frac{N {σ}_{v}^{2}}{t r ( {H}^{H} {H ( {H}^{H} H + {σ}_{n}^{2} I )}^{- 2} )}$$

where tr(·) indicates trace of. With σᵥ set equal to ρδₛ, where δₛ is the minimum distance between points of the symbol constellations and p is a constant to be found experimentally, σᵥ², is found. Note that ρ is a scaling parameter that controls a size of a noise sampleable space.
(3) Generate a stochastic sample ŝ=[s_{center}+v] where [·] denotes a hard decision to closest valid constellation point.

Steps 2 and 3 are repeated until a list of Li unique samples is obtained. This list is referred to herein as [symbol] .

Since the MMSE solution s_{center}=Wy provides a sampling center that minimizes ∥y−Hs∥², in a statistical sense, it should not be far from the ML solution S_{ML}.

$${s}_{center} = {WHs}_{t x} + Wn \qquad ( 4 )$$

where the subscript ‘tx’ has been added to s to emphasize that it is the transmitted symbol vector. It should be noted that while the first term on the right-hand side of (4) comes from the transmitted symbol vector, the second term is a contributor from the channel noise. It may be further noted that with W=W_{MMSE}, this first term can be rearranged as

$${WHs}_{t x} = {s}_{t x} - {{σ}_{n}^{2} ( {H}^{H} H + {σ}_{n}^{2} I )}^{- 1} {s}_{tx} \approx {s}_{tx} \qquad ( 5 )$$

where the approximation to the second line here follows since for typical values of SNR the size of the term σₙ²(H^{H}H+σₙ²I)⁻¹, for most cases, vanishes to a negligible value, hence, may be ignored.

Substituting (5) into (4),

$${s}_{center} \approx {s}_{t x} + Wn \qquad ( 6 )$$

Random choices of v′ and substitution of the result in v=Wv′ and then in ŝ=[s_{center}+v], for some choices of v′ that fall close to −n can remove a good portion of Wn from s_{center}, leading to a set of desirable samples at the vicinity of sₜₓ, hence, near s_{ML}. The process of generating dependent samples that is introduced below will further improve the quality of the samples.

The preceding illustrates how independent samples are generated. The Following illustrates how dependent samples are generated. Thus, an additional step is illustrated for the sampling process that improves on the quality of the finalized samples at low additional computational complexity cost. From the equations above,

$${Wv}^{′} = U 1 \\ where \qquad ( 7 )$$

$$U = {WV}^{′} \qquad ( 8 )$$

V′=diag[v′], i.e., the diagonal matrix whose diagonal elements are the elements of v′, and 1 is a column vector of ones.

For any given sample of v, a sign change of the real or imaginary part of any element of v′ results in another sample within the desired Gaussian distribution. The original sample v is designated as an independent sample, while any sign change of one or more elements in v′ is considered as a dependent sample.

For each sample v′, Embodiments first generate the independent sample

$${\hat{s}}_{i} = ⌊ {s}_{center} + U 1 ⌋ \qquad ( 9 )$$

and, subsequently, a set of dependent samples

$${\hat{s}}_{d} = {s}_{center} + Ua \qquad ( 10 )$$

are generated. In (10), each choice of a is a vector with random elements of +1 or −1. Recalling that the length of a is N, there exist 2^{N} different choices for a, including the case of a=1. In some embodiments, the sign changes are applied to real and imaginary parts of elements of v′, leading to 2^{2N} different choices of the vector v.

In an alternative embodiment, a subset of the choices for a are selected to keep the complexity of the receiver 104 lower.

Assuming that for each independent sample, L_{d} dependent samples are generated, a total of Lᵢ(L_{d}+1) samples of s are obtained, after combining both independent and dependent samples in the list [symbol] . Next, the top K distinct samples of s which result in the smallest values of ∥y−Hs∥² are chosen as the finalized list [symbol] to be used n the iterative detection portion of the receiver 104. Accordingly, the LLR values in (4) are approximated by

$${λ}_{k}^{e} \approx \frac{1}{2} {max}_{x ∈ {𝕃}^{k +}} \{ - \frac{1}{{σ}^{2}} {‖ y - Hs ‖}^{2} + {x}_{∖ k}^{T} \cdot {λ}_{∖ k}^{a} \} - \frac{1}{2} {max}_{x ∈ {𝕃}^{k -}} \{ - \frac{1}{{σ}^{2}} {‖ y - Hs ‖}^{2} + {x}_{∖ k}^{T} \cdot {λ}_{∖ k}^{a} \} \qquad ( 11 )$$

In some embodiments the number of dependent samples, L_{d} are set to be equal to the MIMO size N. These particular choices of a vectors are implemented as an engineering compromise reducing the complexity of generation of dependent samples. This can be understood by noting that an independent sample is obtained by letting a=a₀=1 in (10), and the subsequent dependent samples are obtained by using a₁ through a_{N}. Moreover, making note of the fact that a₀−aᵢ, for i=1, 2, . . . , N, are a set of vectors with one non-zero entry, equal to 2, the ith dependent value of the vector v can be obtained as vᵢ=v₀−U(a₀−aᵢ)=v₀−2uᵢ, where v₀=Ua₀ is the independent value of v and uᵢ is the ith column of U. This can be implemented through a set of shift and subtract operations. Indeed, in some embodiments, this may be implemented in a fashion where no multiplication is involved.

In alternative embodiments at the other extreme, a more diversified set of dependent samples can be obtained if embodiments use all permutations of signs of real and imaginary parts of element of v′. There are 2^{2N}−1 such permutations, hence, the number of dependent samples, for each independent sample, may be increased to as large as 2^{2N}−1. This can lead to a performance improvement at a cost of significant increase in computational cost. Thus, the values of L_{d} may be selected based on engineering considerations where smaller values of L_{d} may be preferred as a compromised choice resulting in lower performance, but corresponding lower computational cost than when larger values of L_{d} are used.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

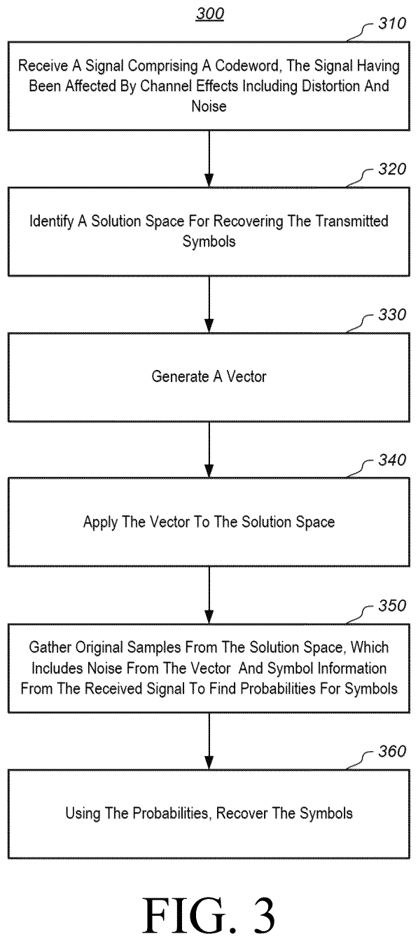

Referring now to FIG. 3, a method 300 is illustrated. The method 300 includes acts for recovering transmitted symbols. While the method is set forth using various variables and symbols, it should be appreciated that this is merely for convenience of explanation and the use of other symbols and variables having the same functionality are contemplated to be within the scope of the claims as claimed.

The method 300 includes receiving a signal comprising a codeword, the signal having been affected by channel effects including distortion and noise (act 310).

The method 300 further includes identifying a solution space for recovering the transmitted symbols (act 320). Identifying a solution space, in one example embodiment, comprises finding a sampling center using a full matrix W for minimum mean square error.

The method 300 further includes generating a vector (act 330). In this example, the vector is referenced as V′ is used to generate noise, and has a predefined variance

The method 300 further includes applying the vector v to the solution space (act 340).

The method 300 further includes gathering original samples from the solution space, which includes noise from the vector v′ and symbol information from the received signal to find probabilities for symbols (act 350).

The method 300 further includes using the probabilities, recovering the symbols (act 360).

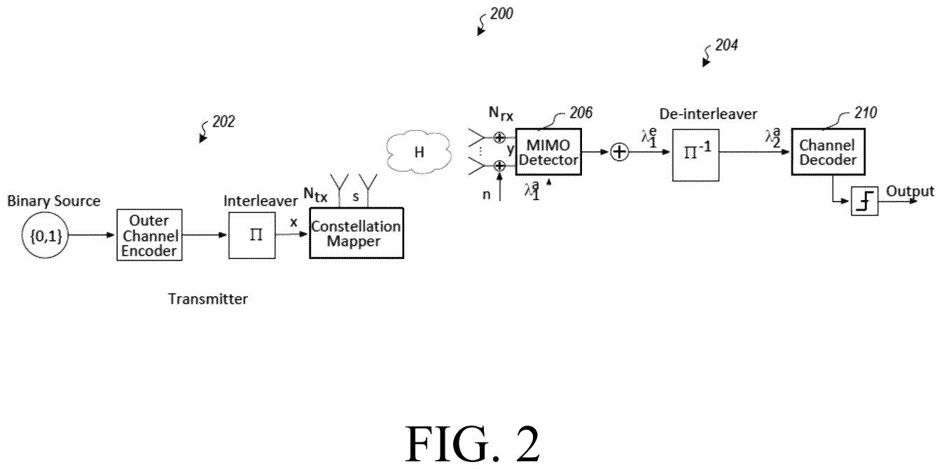

The method 300 described up to this point has been illustrated as a method of obtaining independent samples. Further, the particular method shown does not incorporate some of the iterative elements described above for certain embodiments. Thus, the method 300 up to this point may be practiced in an alternative MIMO system 200 illustrated in FIG. 2, showing a transmitter 202, receiver 204, detector 206, de-interleaver 208 and channel decoder 210.

However, the method 300 may further include elements for collecting dependent samples. For example, the method 300 may include obtaining a change vector. For example, the change vector may be a vector constructed from v′ but where a sign change of any element of v′ results in another sample within a desired Gaussian or other distribution. In such an example, the change vector is applied to the vector to create a dependent vector. Embodiments apply the dependent vector to the solution space to generate additional samples different from the original samples. The additional samples are gathered from the solution space to find additional probabilities for symbols. In this case, recovering the symbols comprises using the probabilities and the additional probabilities.

The method 300 may be practiced where the vector v comprises a zero mean.

The method 300 may be practiced where the vector v′ comprises independent and identically distributed random variables.

The method 300 may be practiced where the vector v′ comprises Gaussian white noise.

The method 300 may be practiced where applying the perturbation vector v to the solution space comprises translating the vector V′ to the sample space using the full matrix W.

The method 300 may be practiced where the probabilities are expressed as log likelihood ratios.

The method 300 may be practiced where gathering samples from the solution space comprises using stochastic sampling.

The method 300 may be practiced where gathering samples from the solution space comprises using iterative stochastic sampling.

The method 300 may be practiced where gathering samples from the solution space comprises using

$${λ}_{k}^{e} \approx \frac{1}{2} {max}_{x ∈ {𝕏}^{k +}} \{ - \frac{1}{{σ}^{2}} {‖ y - Hs ‖}^{2} + {x}_{∖ k}^{T} \cdot {λ}_{∖ k}^{a} \} - \frac{1}{2} {max}_{x ∈ {𝕏}^{k -}} \{ - \frac{1}{{σ}^{2}} {‖ y - Hs ‖}^{2} + {x}_{∖ k}^{T} \cdot {λ}_{∖ k}^{a} \} .$$

The method of claim 1, wherein gathering samples from the solution space comprises using

$${λ}_{k}^{e} \approx \frac{1}{2} {max}_{x ∈ {𝕃}^{k +}} \{ - \frac{1}{{σ}^{2}} {‖ y - Hs ‖}^{2} + {x}_{∖ k}^{T} \} - \frac{1}{2} {max}_{x ∈ {𝕃}^{k -}} \{ - \frac{1}{{σ}^{2}} {‖ y - Hs ‖}^{2} + {x}_{∖ k}^{T} \} .$$

The method 300 may be practiced where W=(H^{H}H+σₙ²)⁻¹H^{H}.

Note that while the examples herein have been illustrated in QAM systems, it should be appreciated that embodiments can be implemented in other linear modulation systems, such as PSK and PAM systems.

Further, the methods may be practiced by a computer system including one or more processors and computer-readable media such as computer memory. In particular, the computer memory may store computer-executable instructions that when executed by one or more processors cause various functions to be performed, such as the acts recited in the embodiments.

Iterative Single Carrier Stochastic Detection with Interference Cancellation

Conventional solutions exist for mitigating the effects of interference. The conventional solutions include (i) a first solution involving a minimum mean squared error equalization using a priori information, (ii) a second solution involving decision feedback equalization, (iii) a third solution involving turbo equalization, and (iv) fourth solution involving block decision feedback equalization, and (v) a fifth solution involving a sphere decoder extended for frequency selective channels. The first solution (i) comprises performing single symbol detection and matrix inversion for each detected symbol. The second solution (ii) comprises performing a serial algorithm that suffers from error propagation. The third solution (iii) comprises a minimum mean square error decision feedback equalizer (MMSE-DFE) approach that suffers from error propagation. The fourth solution (iv) uses forward and backward equalization to minimize error propagation—the complexity of which increases with marginal performance improvement. The fifth solution (v) uses an algorithm that has a complexity exponential in block length, is suitable for short data lengths, and has an ambiguous spheresearch area.

Therefore, parallel applications with multi-symbol detection methods for mitigating the effects of interference are desired, such as maximum a posteriori detectors, which can reduce system latencies and don't require a unique matrix inversion operation for each symbol detected. The present solution provides such a method that involves iterative single carrier stochastic detection with interference cancellation. The particulars of the method will become evident as the discussion progresses.

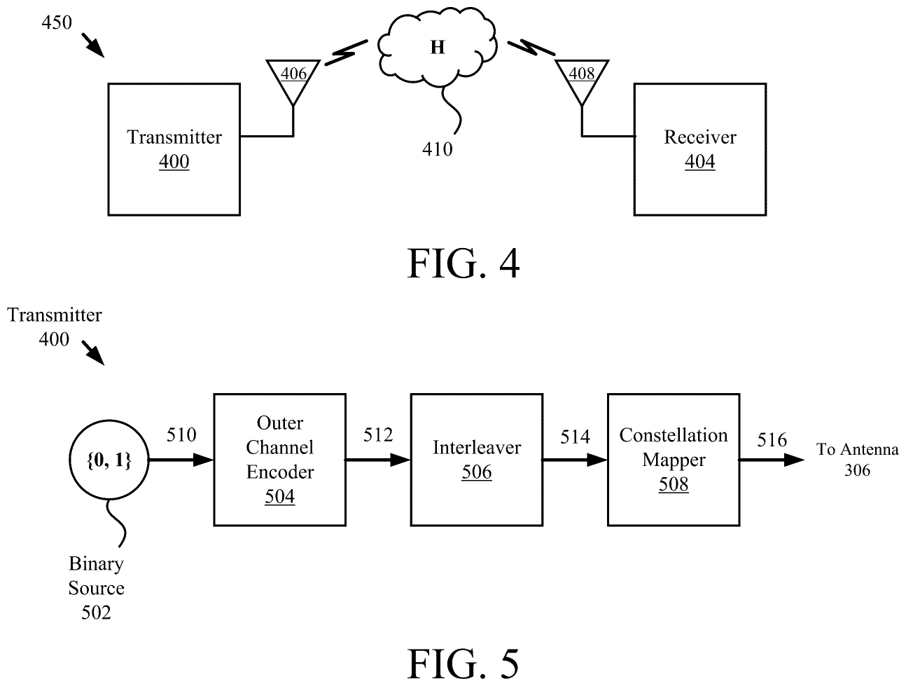

FIG. 4 provides an illustration showing a system 450 for single carrier or single antenna applications. In this regard, system 450 comprises a transmitter 400 with Tx antenna 406 and a receiver 404 with Rx antenna 408. There is multipath in the finite length channel (e.g., L=5), and thus different types of distortion in the carrier. Thus, the above-described symbol detection methods are modified to address this new environment.

During operations, a signal is transmitted from transmitter 400 over a channel 410 via Tx antenna 406. The transmitted signal is received by receiver 404 via Rx antenna 408. The channel 410 comprises a channel that can be represented by a matrix H. Matrix H comprises an N×N square matrix with rows that are rotated versions of each other. An illustrative matrix H is provided below.

$$H = [ \begin{matrix}{h}_{0} & 0 & 0 & 0 & 0 & {h}_{4} & {h}_{3} & {h}_{2} & {h}_{1} \\ {h}_{1} & {h}_{0} & 0 & 0 & 0 & 0 & {h}_{4} & {h}_{3} & {h}_{2} \\ {h}_{2} & {h}_{1} & {h}_{0} & 0 & 0 & 0 & 0 & {h}_{4} & {h}_{3} \\ {h}_{3} & {h}_{2} & {h}_{1} & {h}_{0} & 0 & 0 & 0 & 0 & {h}_{4} \\ {h}_{4} & {h}_{3} & {h}_{2} & {h}_{1} & {h}_{0} & 0 & 0 & 0 & 0 \\ 0 & {h}_{4} & {h}_{3} & {h}_{2} & {h}_{1} & {h}_{0} & 0 & 0 & 0 \\ 0 & 0 & {h}_{4} & {h}_{3} & {h}_{2} & {h}_{1} & {h}_{0} & 0 & 0 \\ 0 & 0 & 0 & {h}_{4} & {h}_{3} & {h}_{2} & {h}_{1} & {h}_{0} & 0 \\ 0 & 0 & 0 & 0 & {h}_{4} & {h}_{3} & {h}_{2} & {h}_{1} & {h}_{0}\end{matrix} ]$$

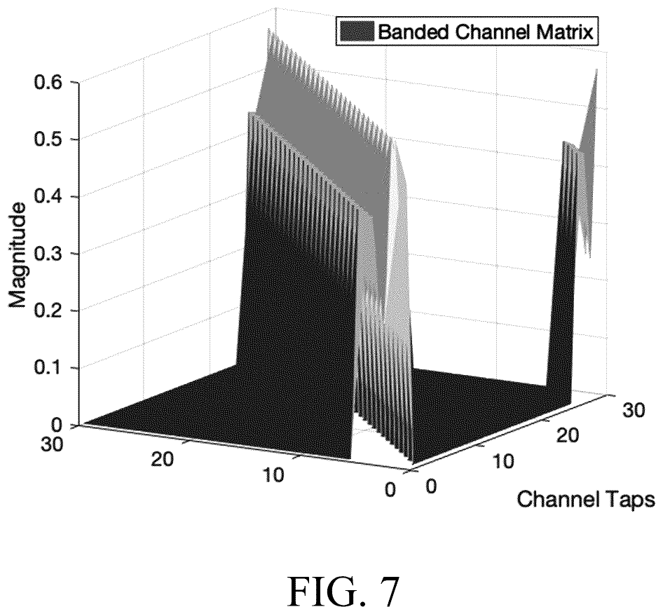

FIG. 7 provides a graph showing a banded matrix or a 3D view of the channel 410.

FIG. 5 provides a more detailed illustration of transmitter 400. Transmitter 400 comprises a binary source 502, an outer channel encoder 504, an interleaver 506 and a constellation mapper 508. Binary source 502 is generally configured to provide binary data 510 (e.g., a sequence of binary numbers 0 and 1) to the outer channel encoder 504. Encoder 504 converts the binary data 510 into an N-bit code 512. The N-bit code 512 is passed to interleaver 512. Interleaver 512 is generally configured to re-arrange the bits in the N-bit code 512 to improve error correction and data transmission. The re-arranged data 514 is passed to constellation mapper 508. Constellation mapper 508 translates the bits in the re-arranged data 514 into specific points on a constellation diagram. This involves assigning each combination of bits to a unique amplitude and phase value that represents a modulated signal 516 to be transmitted.

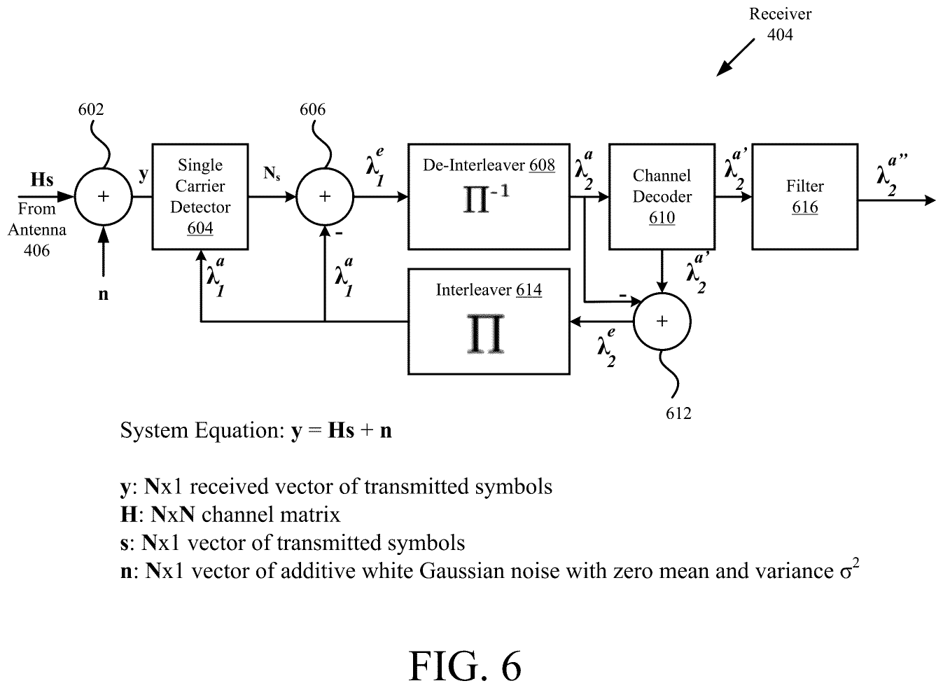

FIG. 6 provides a more detailed illustration of receiver 404. Receiver 404 may be referred to as a soft input soft output (SISO) maximum a posteriori (MAP) iterative receiver. Receiver 404 comprises combiners 602, 606, 612, a single carrier detector 604, a de-interleaver 608, an interleaver 614, a channel decoder 610, and a filter 616.

Combiner 602 combines a vector Hs of received symbols with a vector n of additive white Gaussian noise (AWGN) with zero mean and variance σ². The result of this combining operation is referred to herein as a received vector of transmitted symbols, which may be defined by the following mathematical equation (12).

$$y = Hs + n \qquad ( 12 )$$

wherein s represents an N×1 vector of transmitted symbols. Signal y is provided to the signal carrier detector 604 for symbol detection.

Signal carrier detector 604 is configured to implement operations defined by the following mathematical equations (13)-(15).

### Characteristic Equation:

$$\hat{s} = {arg min}_{s ∈ S} {‖ y - Hs ‖}^{2} \qquad ( 13 )$$

### Characteristic Equation—Interference Cancellation:

$$\hat{s} = {arg min}_{s ∈ S} ‖ y - {Hs}_{{N}_{s}} - {Hs}_{{N}_{IC}} {‖}^{2} \qquad ( 14 )$$

### Log Likelihood Ratio:

$${λ}_{k}^{e} \approx \frac{1}{2} {max}_{x ∈ {𝕏}^{k +}} \{ - \frac{1}{{σ}^{2}} ‖ y - Hs - {Hs}_{{N}_{IC}} {‖}^{2} + {x}_{∖ k}^{T} \cdot {λ}_{∖ k}^{a} \} - \frac{1}{2} {max}_{x ∈ {𝕏}^{k -}} \{ - \frac{1}{{σ}^{2}} ‖ y - Hs - {Hs}_{{N}_{IC}} {‖}^{2} + {x}_{∖ k}^{T} \cdot {λ}_{∖ k}^{a} \} \qquad ( 15 )$$

where H_{SNs} represents the received symbols that are to be detected and H_{SNIC} represents interference components of the received signal.

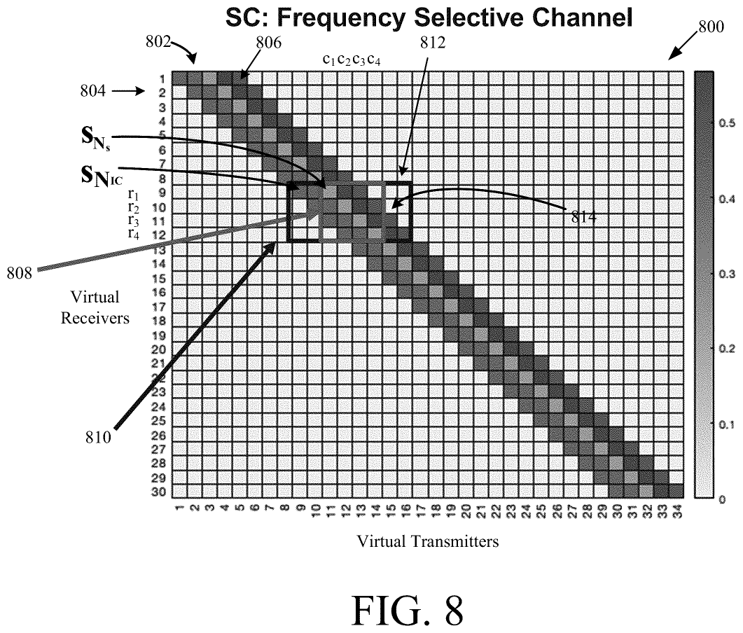

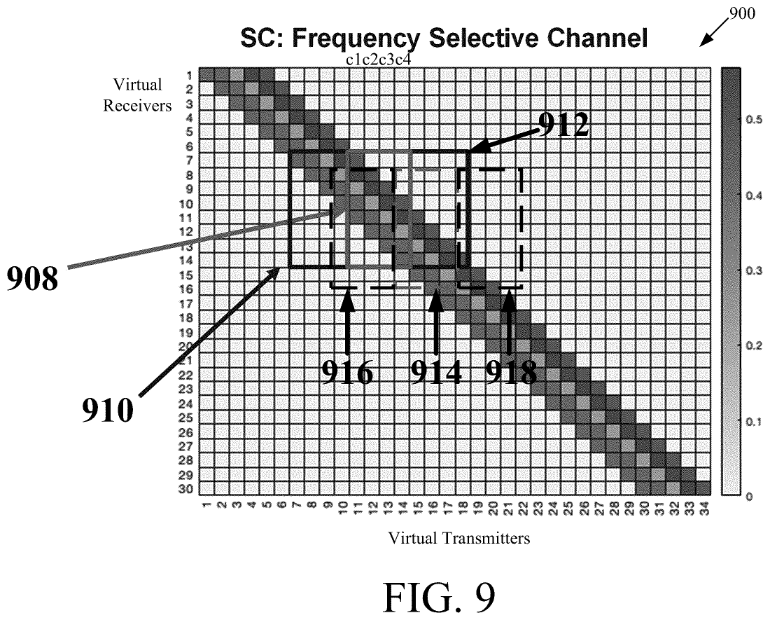

The operations of block 604 may be understood with reference to FIGS. 8-9. FIG. 8 provides a table 800 with a plurality of columns 802 and a plurality of rows 804. The columns represent time delayed transmission of symbols. Each cell of table 800 represents a time instance that a symbol may be transmitted. The dark colored cells 806 of table 800 indicate that there has been a transmission and at that time instance there is energy for a symbol in the channel. The light-colored squares 814 indicate that there has not been a transmission and there is no energy in the channel at that time. The symbols S_{Ns} in block 808 are to be detected. Thus, block 808 represents a desired channel matrix. The symbols SNIC in blocks 810, 812 are treated as interference to be canceled from the received signal.

In a MIMO sense, each column of table 800 may be considered transmission times for a respective virtual transmitter of a plurality of virtual transmitters (e.g., represented by numbers 1-34 on the bottom horizontal axis). Each row of table 800 may be considered receive times for a respective virtual receiver of a plurality of virtual receivers (e.g., represented by numbers 1-30 on the left-side vertical axis). Thus, in the case of FIG. 8, the signal carrier detector 604 may consider the detection problem in a single carrier, single antenna environment as an eight virtual transmitter, four virtual receiver matrix. Blocks 808, 908 represents H_{SNs} in mathematical equation (14), while blocks 810/812, 910/912 represent H_{SNIC} in mathematical equation (14). FIG. 9 provides another graph 900 showing an expanded version of that shown in FIG. 8. In this case, the signal carrier detector 604 may consider the detection problem in a single carrier, single antenna environment as a four virtual transmitter, eight virtual receiver matrix.

In view of FIGS. 8-9, a stochastic detection algorithm similar to that discussed above in the MIMO applications may be employed by signal carrier detector 604 for symbol detection purposes in a single carrier transmission system. The stochastic detection algorithm implemented by signal carrier detector 604 considers each of the plurality of symbols S_{Ns} and/or SNIC as being transmitted from respective virtual transmitters and received by respective virtual receivers. For example, in FIG. 8, the symbols in column c₁ are considered as having been transmitted from the eleventh virtual transmitter, while the symbols in column c₂ are considered as having been transmitted from twelfth virtual transmitter, the symbols in column c₃ are considered as having been transmitted from the thirteenth virtual transmitter, and the symbols in column c₄ are considered as having been transmitted from fourteenth virtual transmitter. The symbols in row r1 are considered as having been received by the ninth virtual receiver, while the symbols in row r2 are considered as having been received by the tenth virtual receiver, the symbols in row r3 are considered as having been received by eleventh virtual receiver, and the symbols in row r4 are considered as having been received by twelfth virtual receiver. The present solution is not limited to the particulars of this example.

Referring back to FIG. 6, the operations of signal carrier detector 604 may generally involve detecting Ns symbols per detection event. The detected symbols Nₛ are passed to combiner 606 where they are combined with feedback interleaved data. The feedback interleaved data may be represented as bit sequence λ₁^{a}. The result of this combining operation may be represented as bit sequence λ₁^{e}. Bit sequence λ₁^{e} may be defined by the following mathematical equation (16).

$${λ}_{1}^{e} = {N}_{s} + - {λ}_{1}^{a} \qquad ( 16 )$$

De-interleaver 608 is generally configured to process λ₁^{e} to reverse the data interleaving performed at the transmitter 400. Any known or to be known techniques for reversing data interleaving may be used here. The de-interleaved data may be represented as a bit sequence λₛ^{a}. The de-interleaved data is passed to channel decoder 610.

Channel decoder 610 is generally configured to perform an inverse mapping of the channel output bit sequence λ₂^{a} into an output bit sequence λ₂^{a}. This may be achieved by restoring binary data to its original form by removing redundancy and correcting errors that may have occurred during transmission. Output bit sequence λ₂^{a} may be filtered in block 516 to produce a filtered output bit sequence λ₂^{a}.

The de-interleaved data λₛ^{a} is also passed to combiner 612 where it is combined with the output bit sequence λ₂^{a} of channel decoder 610. The result of this combination operation may be represented as λ₂^{e}. λ₂^{e} may be defined by the following mathematical equation (17).

$${λ}_{2}^{e} = - {λ}_{s}^{a} + {λ}_{2}^{{a}^{′}} \qquad ( 17 )$$

λ₂^{e} is passed to interleaver 614. Interleaver 614 is generally configured to re-arrange the bits in λ₂^{e} in the same manner as that done by interleaver 606 of transmitter 400. The re-arranged data may be represented as λ₁^{a} and is provided to signal carrier detector 604 and combiner 606 as mentioned above.

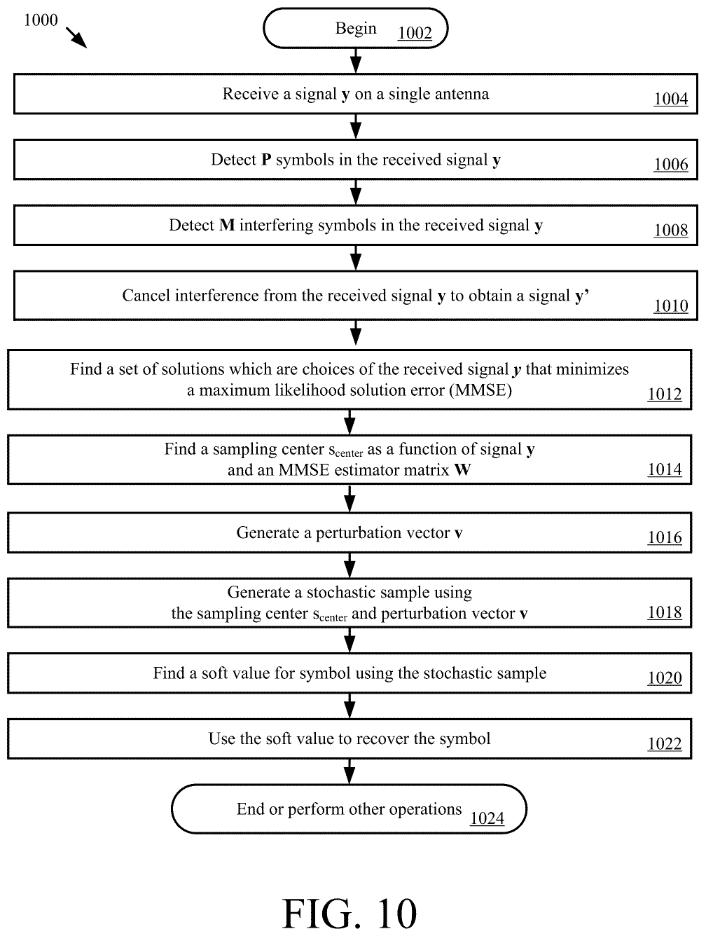

FIG. 10 provides a flow diagram of an illustrative method 1000 for detecting symbols in a system (e.g., system 450 of FIG. 4) in which a single carrier is used to transmit symbols from a single antenna (e.g., antenna 406 of FIG. 4). Method 1000 begins with 1002 and continues to 1004 where a signal y is received at a signal carrier detector (e.g., signal carrier detector 604 of FIG. 6) of a receiver (e.g., receiver 404 of FIG. 4). The signal carrier detector performs operations in block 1006 to detect P symbols of interest (e.g., symbols S_{Ns}) in the received signal y, and performs operations in block 1008 to detect M interfering symbols (e.g., symbols SNIC) in the received signal y. Each of P and M is an integer selected in accordance with a given application. For example, P is selected to be four, while M is selected to be eight. The present solution is not limited to the particulars of this example.

In block 1010, the signal carrier detector performs operations to cancel interference from the received signal y to obtain a signal y′. Signal y′ may be defined by the following mathematical equation (18).

$${y}^{′} = y - {H}_{SNIC} \qquad ( 18 )$$

Signal y′ is then used in block 1012 to find a set of solutions which are choices of the received signal y that minimizes a maximum likelihood solution error (MMSE). The MMSE may be defined by the following mathematical equation (19).

$${‖ {y}^{′} - {Hs}_{{N}_{s}} ‖}^{2} \qquad ( 19 )$$

Next in block 1014, the signal carrier detector performs operations to find a sampling center s_{center} as a function of the received signal y and an MMSE estimator matrix W. The sampling center s_{center} may be defined by mathematical equation (20).

$${s}_{center} = Wy \qquad ( 20 )$$

where MMSE estimator matrix W may be defined by mathematical equation (21).

$$W = {( {H}^{H} H + {σ}_{n}^{2} I )}^{- 1} {H}^{H} \qquad ( 21 )$$

In block 1016, the signal carrier detector performs operations to generate a perturbation vector v. Perturbation vector v may be defined by mathematical equation (22).

$${v = W v}^{′} \qquad ( 22 )$$

where v′ is a vector of independent and identically distributed (i.i.d.) Gaussian elements with zero mean and variance σᵥ². To find the diversity of samples, the standard deviation of the elements of v should be comparable with the distance between constellation points:

$${σ}_{{v}^{′}}^{2} = \frac{N {σ}_{v}^{2}}{tr ( {H}^{H} {H ( {H}^{H} H + {σ}_{n}^{2} I )}^{- 2} )} . \qquad ( 23 )$$

In block 1018, the signal carrier detector performs operations to generate a stochastic sample 9 using the sampling center s_{center} and the perturbation vector v. The stochastic sample s may be defined by the following mathematical equation (24).

$$\hat{s} = ⌊ {s}_{center} + v ⌋ \qquad ( 24 )$$

where [·] denotes a hard decision to a closest constellation point.

In bock 1020, the signal carrier detector performs operations to find a soft value for a symbol using the stochastic sample ŝ. The soft value may comprise a log liklihood ratio defined by above mathematical equation (15). The soft value may be used in block 1022 to recover the symbol. Subsequently, method 1000 continues to block 1024 where it ends or other operations are performed (e.g., return to 1102).

It should be noted that some or all of the operation of method 1000 may be performed in a parallel processing algorithm to reduce latency. For example, a first parallel processing branch may process symbols in blocks 908, 910, 912, while a second parallel processing branch processes symbols in blocks 914, 916, 918.

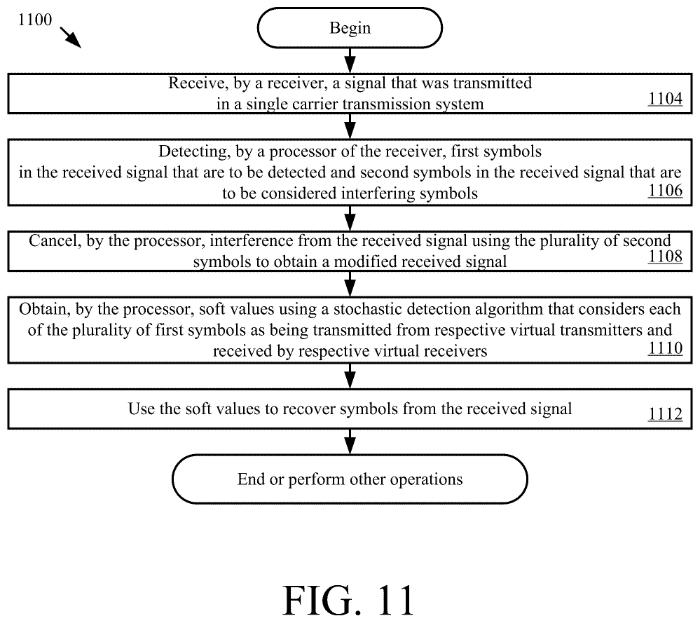

FIG. 11 provides a flow diagram of an illustrative method 1100 for symbol detection. Method 1100 involves: (block 1104) receiving, by a receiver (e.g., receiver 404 of FIG. 4 and FIG. 6), a signal (e.g., signal y of FIG. 6) that was transmitted in a single carrier transmission system (e.g., system 450 of FIG. 4); (block 1106) detecting, by a processor (e.g., signal carrier detector 604 of FIG. 6) of the receiver, a plurality of first symbols in the received signal that are to be detected and a plurality of second symbols in the received signal that are to be considered interfering symbols; (block 1108) cancelling, by the processor, interference from the received signal using the plurality of second symbols to obtain a modified received signal; (block 1110) obtaining, by the processor, soft values using a stochastic detection algorithm that considers each of the plurality of first symbols as being transmitted from respective virtual transmitters and received by respective virtual receivers; and (block 1112) using the soft values to recover symbols from the received signal.

The second symbols may comprise symbols occurring before the first symbols in the received signal and symbols occurring after the first symbols in the received signal. The interference may be cancelled from the received signal in accordance with the following mathematical equation y′=y−H_{SNIC}, where y represents the received signal, y′ represents the modified received signal, and H_{SNIC} represents the plurality of second symbols. The modified received signal may be used in block 1110 to find a set of solutions which are choices of the received signal that minimizes a maximum likelihood solution error ∥y′−H_{S}_{_{Ns}}∥². Block 1110 may also involve: finding a sampling center as a function of the received signal and a minimum mean square error estimator matrix; generating a perturbation vector as a function of the minimum mean square error estimator matrix and a vector of independent and identically distributed random variables; and/or generating a stochastic sample using the sampling center and the perturbation vector. The vector of independent and identically distributed random variables comprises a zero mean and/or Gaussian white noise. The soft values are obtained using the stochastic sample. The soft values may be expressed as log likelihood values.

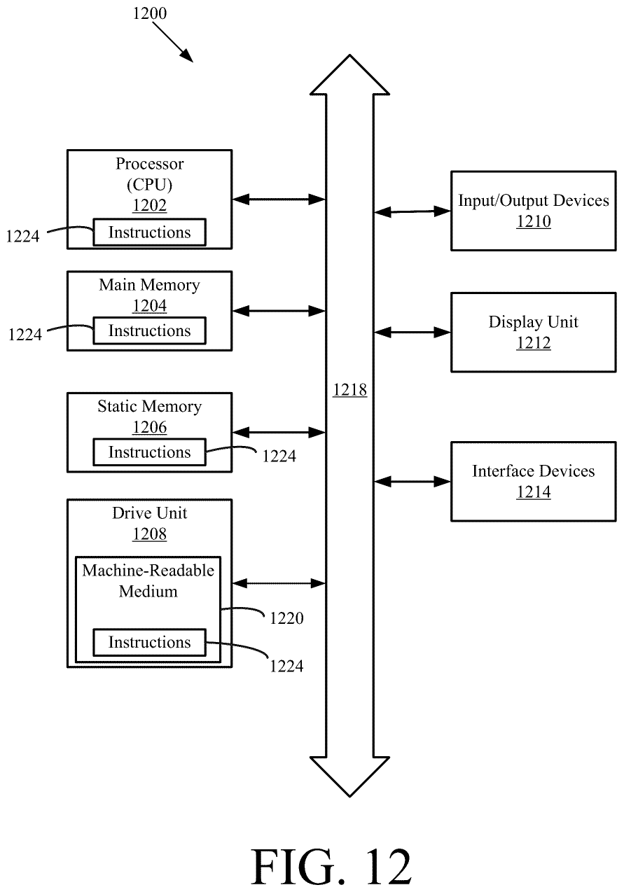

FIG. 12 provides an illustration of a hardware block diagram for a computer system 1200 that can be used for implementing all or part of transmitter 400 and/or receiver 402 of FIG. 4. The machine can include a set of instructions which are used to cause the circuit/computer system to perform any one or more of the methodologies discussed herein. While only a single machine is illustrated in FIG. 12, it should be understood that in other scenarios the system can be taken to involve any collection of machines that individually or jointly execute one or more sets of instructions as described herein.

The computer system 1200 is comprised of a processor 1202 (e.g., a central processing unit (CPU)), a main memory 1204, a static memory 1206, a drive unit 1208 for mass data storage and comprised of machine-readable media 1220, input/output devices 1210, a display unit 1212 (e.g., a liquid crystal display (LCD) or a solid state display, and one or more interface devices 1214. Communications among these various components can be facilitated by means of a data bus 1218. One or more sets of instructions 1224 can be stored completely or partially in one or more of the main memory 1204, static memory 1206, and drive unit 1208. The instructions can also reside within the processor 1202 during execution thereof by the computer system. The input/output devices 1210 can include a keyboard, a multi-touch surface (e.g., a touchscreen), and so on. The interface device(s) 1214 can be comprised of hardware components and software or firmware to facilitate an interface to external circuitry. For example, in some scenarios, the interface devices 1214 can include one or more analog-to-digital (A/D) converters, digital-to-analog (D/A) converters, input voltage buffers, output voltage buffers, voltage drivers and/or comparators. These components are wired to allow the computer system to interpret signal inputs received from external circuitry and generate the necessary control signals for certain operations described herein.

The drive unit 1208 can comprise a machine-readable medium 1220 on which is stored one or more sets of instructions 1224 (e.g., software) which are used to facilitate one or more of the methodologies and functions described herein. The term “machine-readable medium” shall be understood to include any tangible medium that is capable of storing instructions or data structures which facilitate any one or more of the methodologies of the present disclosure. Exemplary machine-readable media can include solid-state memories, electrically erasable programmable read-only memory (EEPROM), and flash memory devices. A tangible medium as described herein is one that is non-transitory insofar as it does not involve a propagating signal.

Computer system 1200 should be understood to be one possible example of a computer system which can be used in connection with the various implementations disclosed herein. However, the systems and methods disclosed herein are not limited in this regard and any other suitable computer system architecture can also be used without limitation. Dedicated hardware implementations including, but not limited to, application-specific integrated circuits, programmable logic arrays, and other hardware devices can likewise be constructed to implement the methods described herein. Applications that can include the apparatus and systems broadly include a variety of electronic and computer systems. Thus, the exemplary system is applicable to software, firmware, and hardware implementations.

As evident from the above discussion, the present solution concerns implementing systems and methods for symbol detection. The methods comprise: receiving, by a receiver, a signal that was transmitted in a single carrier transmission system; detecting, by a processor of the receiver, a plurality of first symbols in the received signal that are to be detected and a plurality of second symbols in the received signal that are to be considered interfering symbols; cancelling, by the processor, interference from the received signal using the plurality of second symbols to obtain a modified received signal; obtaining, by the processor, soft values using a stochastic detection algorithm that considers each of the plurality of first symbols as being transmitted from respective virtual transmitters and received by respective virtual receivers; and using the soft values to recover symbols from the received signal.

The plurality of second symbols may comprise symbols occurring before the first symbols in the received signal and symbols occurring after the first symbols in the received signal. The interference may be cancelled from the received signal in accordance with the following mathematical equation y′=y−H_{SNIC}, where y represents the received signal, y′ represents the modified received signal, and H_{SNIC} represents the plurality of second symbols.

The methods may further comprise: using the modified received signal to find a set of solutions which are choices of the received signal that minimizes a maximum likelihood solution error ∥y′−H_{S}_{_{Ns}}∥²; finding a sampling center as a function of the received signal and a minimum mean square error estimator matrix; generating a perturbation vector as a function of the minimum mean square error estimator matrix and a vector of independent and identically distributed random variables; and/or generating a stochastic sample using the sampling center and the perturbation vector. The vector of independent and identically distributed random variables may comprise a zero mean and/or Gaussian white noise. The soft values may be obtained using the stochastic sample. The soft values may be expressed as log likelihood values.

The present solution also concerns a system, comprising: a receiver configured to receive a signal that was transmitted in a single carrier transmission system; and a processor configured to recover symbols from the received signal. The symbols are recovered by: detecting a plurality of first symbols in the received signal that are to be detected and a plurality of second symbols in the received signal that are to be considered interfering symbols; cancelling interference from the received signal using the plurality of second symbols to obtain a modified received signal; obtaining soft values using a stochastic detection algorithm that considers each of the plurality of first symbols as being transmitted from respective virtual transmitters and received by respective virtual receivers; and using the soft values to recover the symbols from the received signal.

The plurality of second symbols may comprise symbols occurring before the first symbols in the received signal and symbols occurring after the first symbols in the received signal. The interference may be cancelled from the received signal in accordance with the following mathematical equation y′=y−H_{SNIC}, where y represents the received signal, y′ represents the modified received signal, and H_{SNIC} represents the plurality of second symbols.

The processor may be further configured to: use the modified received signal to find a set of solutions which are choices of the received signal that minimizes a maximum likelihood solution error ∥y′−H_{S}_{_{Ns}}∥²; find a sampling center as a function of the received signal and a minimum mean square error estimator matrix; generate a perturbation vector as a function of the minimum mean square error estimator matrix and a vector of independent and identically distributed random variables; and/or generate a stochastic sample using the sampling center and the perturbation vector. The vector of independent and identically distributed random variables may comprise a zero. The soft values may be obtained using the stochastic sample. The soft values may be expressed as log likelihood values.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer-readable storage media and transmission computer-readable media.

Physical computer-readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer-readable media to physical computer-readable storage media (or vice versa). For example, computer-executable instructions or data structures received over a network or data link can be buffered in RAM within a network interface module (e.g., a “NIC”), and then eventually transferred to computer system RAM and/or to less volatile computer-readable physical storage media at a computer system. Thus, computer-readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer-executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc.

As used in this document, the singular form “a”, “an”, and “the” include plural references unless the context clearly dictates otherwise. Unless defined otherwise, all technical and scientific terms used herein have the same meanings as commonly understood by one of ordinary skill in the art. As used in this document, the term “comprising” means “including, but not limited to”.

The present invention may be embodied in other specific forms without departing from its characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A method for symbol detection, comprising:
receiving, by a receiver, a signal that was transmitted in a single carrier transmission system;
detecting, by a processor of the receiver, a plurality of first symbols in the received signal that are to be detected and a plurality of second symbols in the received signal that are to be considered interfering symbols;
cancelling, by the processor, interference from the received signal using the plurality of second symbols to obtain a modified received signal;
obtaining, by the processor, soft values using a stochastic detection algorithm that considers each of the plurality of first symbols as being transmitted from respective virtual transmitters and received by respective virtual receivers; and
using the soft values to recover symbols from the received signal.

2. The method according to claim 1, wherein the plurality of second symbols comprises symbols occurring before the first symbols in the received signal and symbols occurring after the first symbols in the received signal.

3. The method according to claim 1, wherein said interference is cancelled from the received signal in accordance with the following mathematical equation y′=y−H_{SNIC}, where y represents the received signal, y′ represents the modified received signal, and H_{SNIC} represents the plurality of second symbols.

4. The method according to claim 2, further comprising using the modified received signal to find a set of solutions which are choices of the received signal that minimizes a maximum likelihood solution error ∥y′−H_{S}_{_{Ns}}∥².

5. The method according to claim 1, further comprising finding a sampling center as a function of the received signal and a minimum mean square error estimator matrix.

6. The method according to claim 5, further comprising generating a perturbation vector as a function of the minimum mean square error estimator matrix and a vector of independent and identically distributed random variables.

7. The method according to claim 6, wherein the vector of independent and identically distributed random variables comprises a zero mean and/or Gaussian white noise.

8. The method according to claim 6, further comprising generating a stochastic sample using the sampling center and the perturbation vector.

9. The method according to claim 8, wherein the soft values are obtained using the stochastic sample.

10. The method according to claim 1, wherein the soft values are expressed as log likelihood values.

11. A system, comprising:
a receiver configured to receive a signal that was transmitted in a single carrier transmission system; and
a processor configured to recover symbols from the received signal by:
detecting a plurality of first symbols in the received signal that are to be detected and a plurality of second symbols in the received signal that are to be considered interfering symbols;
cancelling interference from the received signal using the plurality of second symbols to obtain a modified received signal;
obtaining soft values using a stochastic detection algorithm that considers each of the plurality of first symbols as being transmitted from respective virtual transmitters and received by respective virtual receivers; and
using the soft values to recover the symbols from the received signal.

12. The system according to claim 11, wherein the plurality of second symbols comprises symbols occurring before the first symbols in the received signal and symbols occurring after the first symbols in the received signal.

13. The system according to claim 11, wherein said interference is cancelled from the received signal in accordance with the following mathematical equation y′=y−H_{SNIC}, where y represents the received signal, y′ represents the modified received signal, and H_{SNIC} represents the plurality of second symbols.

14. The system according to claim 13, wherein the processor is further configured to use the modified received signal to find a set of solutions which are choices of the received signal that minimizes a maximum likelihood solution error y′−H_{S}_{_{Ns}}∥².

15. The system according to claim 11, wherein the processor is further configured to find a sampling center as a function of the received signal and a minimum mean square error estimator matrix.

16. The system according to claim 15, wherein the processor is further configured to generate a perturbation vector as a function of the minimum mean square error estimator matrix and a vector of independent and identically distributed random variables.

17. The system according to claim 16, wherein the vector of independent and identically distributed random variables comprises a zero mean and/or Gaussian white noise.

18. The system according to claim 16, wherein the processor is further configured to generate a stochastic sample using the sampling center and the perturbation vector.

19. The system according to claim 18, wherein the soft values are obtained using the stochastic sample.

20. The system according to claim 11, wherein the soft values are expressed as log likelihood values.
